(19) United States
(12) Patent Application Publication
(10) Pub. No.: US 2026/0273399 A1
(43) Pub. Date: Sep. 17, 2026

(54) ENTERTAINMENT SYSTEM, INFORMATION PROCESSING DEVICE, AND VIDEO PROVIDING METHOD

(71) Applicant: BANDAI NAMCO ENTERTAINMENT INC., tokyo (JP)

(72) Inventor: Hideki YAMADA, Ichikawa-shi (JP)

(73) Assignee: BANDAI NAMCO ENTERTAINMENT INC., tokyo (JP)

(21) Appl. No.: 19/469,165

(22) PCT Filed: Mar. 26, 2024
(86) PCT No.: PCT/JP2024/011905

§ 371 Date: Sep. 25, 2025

(30) Foreign Application Priority Data
Mar. 30, 2023 (JP) 2023-055368

(51) Int. Cl. A63F 13/525; A63F 13/67; G06T 19/00

(52) U.S. Cl. CPC A63F 13/525; A63F 13/67; G06T 19/00

(57) ABSTRACT

An entertainment system provides a video which is highly satisfying to a user based on learning information related to a video. In the entertainment system, at least one virtual camera is disposed in a virtual space. A video viewed from the virtual camera is generated. The learning information related to the video includes evaluation information related to the video, and the video is generated based on the learning information. In the entertainment system, the learning information related to the video includes the evaluation information related to the video. Since the video is generated based on the learning information, the entertainment system can provide the video which is highly satisfying to the user.

### TECHNICAL FIELD

The present invention relates to an entertainment system, an information processing device, and a video providing method.

### BACKGROUND ART

In a three-dimensional virtual space (e.g. game space), a system in which a virtual camera is disposed and an image viewed from the virtual camera is generated, has been known. For example, in PTL 1, a system that performs control of a virtual camera in accordance with a game situation is disclosed (see PTL 1).

Further, in recent years, a game system which uses a learning model generated by analyzing and learning data is available.

### CITATION LIST

### Patent Literature

PTL1: JP 2022-164663 A

### SUMMARY OF INVENTION

### Technical Problem

A problem of the conventional system that controls a virtual camera is that the user has difficulty to control the virtual camera at a high level of satisfaction. It is preferable to learn a video and provide a video which is highly satisfying to a user.

With the foregoing in view, it is an object of the present invention to provide a video which is highly satisfying to a user based on learning information related to the video.

### Solution to Problem

(1) The present invention relates to an entertainment system which provides a video generated in an entertainment content executed in a virtual space, the entertainment system including:
a virtual camera control unit which disposes at least one virtual camera in the virtual space; and
a video generating unit which generates a video viewed from the virtual camera, wherein
learning information related to the video includes evaluation information related to the video, and
the video generating unit generates the video based on the learning information.

The present invention also relates to an information processing device (learning device, terminal device, game device, server device) which provides a video generated in an entertainment content executed in a virtual space, the information processing device including:
a virtual camera control unit which disposes at least one virtual camera in the virtual space; and
a video generating unit which generates a video viewed from the virtual camera, wherein
learning information related to the video includes evaluation information related to the video, and
the video generating unit generates the video based on the learning information.

The present invention also relates to a computer-readable information storage medium storing a program that provides a video generated in an entertainment content executing in a virtual space, and causes a computer to function as:
a virtual camera control unit which disposes at least one virtual camera in the virtual space; and
a video generating unit which generates a video viewed from the virtual camera, wherein
learning information related to the video includes evaluation information related to the video, and
the video generating unit generates a video based on the learning information.

The present invention also relates to a video providing method for providing a video generated in an entertainment content executed in a virtual space, the method including:
disposing at least one virtual camera in the virtual space; and
generating a video viewed from the virtual camera, wherein
learning information related to the video includes evaluation information related to the video, and
in generating the video, the video is generated based on the learning information.

In the present invention, the learning information related to a video includes the evaluation information related to the video. In the present invention, a video is generated on the basis of the learning information, hence a video which is highly satisfying to a user can be provided.

“Learning” refers to machine learning, for example. “Learning” may also be storing (saving) information.
(2) In the entertainment system, the information processing device, the information storage medium and the video providing method according to the present invention, the learning information may include information related to the virtual camera.

According to the present invention, the virtual camera information in the virtual space is used as the learning information, hence a realistic and high quality video can be generated. The virtual camera information in the virtual space includes a position, orientation and viewing angle (angle-of-view) of the virtual camera, for example. Further, by using the virtual camera information in the virtual space as the learning information, the appearance of the generated video can be improved because the position and orientation of the camera, for example, can be optimized.
(3) In the entertainment system, the information processing device, the information storage medium and the video providing method according to the present invention, the learning information may include information related to a subject of the virtual camera.

According to the present invention, information related to a subject of the virtual camera is included (that is, the poses, expressions, motions and the like of the character are included as information related to the subject), hence a video expressing more natural motions can be generated. Further, according to the present invention, more expressive videos can be generated more effectively, since information related to the subject of the virtual camera is included.
(4) In the entertainment system, the information processing device, the information storage medium and the video providing method according to the present invention, the learning information may include information related to a game situation.

According to the present invention, information related to a game situation is included in the learning information, hence more natural videos can be generated. For example, by including information on a game situation where a target character operated by a player is attacking in the learning information, a generated attack scene of the video can be more realistic.

According to the present invention, more expressive videos can be generated since information related to a game situation is included in the learning information. For example, in a case where the game situation is a situation where a target character operated by a player is attacking, tension and the power of the attack can be added to the video.

According to the present invention, more diversified videos can be generated since information related to the game situation is included in the learning information. For example, various videos can be generated by changing the game situation, such as an attack scene of a first character and an attack scene of a second character.
(5) In the entertainment system, the information processing device, the information storage medium and the video providing method according to the present invention, the learning information may include information related to image analysis.

According to the present invention, information related to the image analysis is included in the learning information, hence more accurate videos can be generated. For example, by analyzing a feature value and structure of an image and including the result in the learning information, more accurate videos can be generated.

According to the present invention, more expressive videos can be generated since information related to image analysis is included in the learning information. For example, realistic texture can be added to the video by analyzing the colors and structure of the image.

According to the present invention, more diversified videos can be generated since information related to image analysis is included in the learning information. For example, various videos can be generated by analyzing type of images, shapes of objects (e.g. characters) included in the image, and the like.
(6) In the entertainment system, the information processing device, the information storage medium and the video providing method according to the present invention, the learning information may include learning information of other players.

According to the present invention, learning information of other players is included, hence usability and learning accuracy can be improved.
(7) In the entertainment system, the information processing device, the information storage medium and the video providing method according to the present invention, the evaluation information may be made for the video and may be based on a player's input. According to the present invention, the player can evaluate the video at will.
(8) In the entertainment system, the information processing device, the information storage medium and the video providing method according to the present invention, the evaluation information may be made for the video and may be provided by a plurality of players.

“Evaluation information provided by a plurality of players” here may be regarded as big data. Big data refers to a large volume of diverse data. The volume and types are increased by including the information provided by a plurality of players. For example, a more multifaceted analysis and prediction becomes possible by handling the evaluation information provided by a plurality of players as big data. For example, more accurate prediction can be performed by integrating the evaluation information provided by a plurality of players.
(9) In the entertainment system, the information processing device, the information storage medium and the video providing method according to the present invention, the evaluation information may be information about difference between the video and a predetermined reference video.

According to the present invention, the difference information between the generated video and a predetermined reference video (e.g. animation video, live action video) is used as the evaluation information, hence accurate prediction considering the reference video can be performed. As a result, a realistic video can be provided.
(10) The entertainment system, the information processing device, the information storage medium and the video providing method according to the present invention may further include a selection unit which selects a video to be provided, out of a plurality of generated videos, based on information input by a player.

According to the present invention, a video which the player wants to view can be selected out of a plurality of generated videos, hence a video service which is highly satisfying to the player can be provided.

### BRIEF DESCRIPTION OF DRAWINGS

FIG. 1 illustrates an example of a configuration of a game system of the present embodiment.

FIG. 2 is a functional block diagram of a server device of the present embodiment.

FIG. 3 is a functional block diagram of a terminal device of the present embodiment.

FIG. 4 illustrates generation of a video according to the present embodiment.

FIG. 5 is a table for describing learning information of the present embodiment.

FIG. 6 is a table for describing types and values of a camera work of the present embodiment.

FIG. 7 is a table illustrating a correspondence between a video ID, a learning information ID, and evaluation information of the present embodiment.

FIG. 8 illustrates generation of a video according to the present embodiment.

FIG. 9 illustrates generation of a video according to the present embodiment.

FIG. 10 illustrates video selection according to the present embodiment.

FIG. 11 illustrates generation of a video according to the present embodiment.

FIG. 12 is a flow chart illustrating video generation by AI according to the present embodiment.

### DESCRIPTION OF EMBODIMENTS

Embodiments of the invention will be described below. It is noted that the embodiments to be described below do not unduly limit the contents of the invention described in the claims. Further, all the components described in the embodiments are not necessarily essential requirements of the invention.

### [1] OVERVIEW OF ENTERTAINMENT SYSTEM

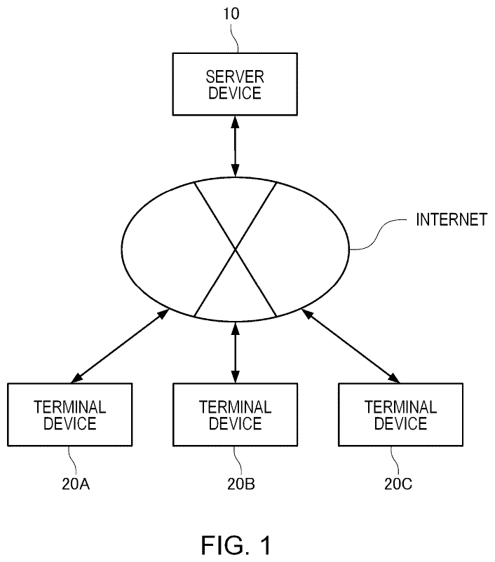

An overview and general configuration of an entertainment system of the present embodiment will be described first with reference to FIG. 1. FIG. 1 illustrates an example of a system configuration indicating a configuration of the entertainment system of the present embodiment.

A server device 10 is an information processing device which can provide a predetermined service using a terminal device (game device) 20, which is communicably connected via the Internet (an example of a network).

The terminal device 20 is an information processing device, such as an image generation device, a business-use game device, an arcade game device, and an arcade cabinet, and includes a home TV game machine, personal computer (PC), smartphone, portable telephone, PHS, computer, PDA and portable game machine. The terminal device 20 can be connected to the server device 10 via a network, such as the Internet (WAN) and LAN. An input unit 260 and a display unit 290 are connected to the terminal device 20.

The terminal device 20 of the present embodiment includes a learning function (e.g. learning function by machine learning). The terminal device 20 may be regarded as a learning device. The terminal device 20 includes an inference function (prediction function) based on the machine learning. The terminal device 20 may be regarded as an inference device (prediction device).

### [1.1] Entertainment System Constituted of Client Server Model

As illustrated in FIG. 1, the entertainment system of the present embodiment is configured such that the server device 10 and the terminal device 20 (e.g. terminal devices 20A, 20B and 20C) are connected to the Internet (an example of a network).

A player (user) accesses the server device 10 from the terminal device 20, so as to play a game based on information which is sent from the server device 10 via the Internet.

Particularly in the present embodiment, information related to the game is provided to the terminal device 20 of the player from the server device 10, which executes a game where a first character and a second character have a match. The information related to the operation input by the player, which is received by the terminal device 20, is sent to the server device 10. The server device 10 sends information related to the game to the terminal device 20.

In the present embodiment, one server device 10 may provide each game to the terminal device 20, or a server system is constructed interlocking a plurality of server devices 10, whereby each game may be provided to the terminal device 20.

Various processing steps related to the present invention may be executed by the server device 10 alone, or various processing steps related to the present invention may be executed by the terminal device 20 alone.

### [1.2] Terminal Device

The entertainment system of the present embodiment may be implemented by a single terminal device which includes the functions of the server device 10, that is, by a standalone device which operates alone without depending on other devices, such as the server device.

In the present embodiment, the present invention may be implemented by the terminal devices 20 alone, without being connected to the server device 10. For example, the entertainment system may be implemented by a plurality of terminal devices 20 based on P2P (peer-to-peer) communication.

A plurality of such terminal devices may be connected wirelessly or via cables, and one of the terminal devices may function as a host (server device 10), so as to implement the entertainment system of the present embodiment by a plurality of terminal devices.

The terminal device is not only the terminal device mentioned above, but also may be a tablet type information terminal device, a personal computer, or a terminal device (arcade cabinet) installed in an amusement park.

### [1.3] Cloud-Based Entertainment System

The entertainment system of the present embodiment may be a cloud-based entertainment system. For example, in a cloud-based entertainment system, basic processing (including game processing and drawing processing) is executed by the server device 10 (cloud device) alone, and the terminal device 20 side only executes display control of the processing result of the server device 10 (cloud device). The terminal device 20 also sends information, such as operation input by the controller (operation information, input information) to the server device 10. In this case, the terminal device 20 may also send information other than the operation input.

In the present embodiment, the above mentioned game may be implemented by the server device 10 executing each function of the processing unit 200 of the terminal device 20, and executing the game program, excluding the input, and the terminal device 20 executing input and image display by streaming.

The entertainment system may store information to be stored in the server device 10 and information to be stored in the terminal device 20 in a predetermined storage area on the Internet.

### [1.4] Terminal Device Including Plurality of Controllers

In the present embodiment, one terminal device 20 may include a plurality of controllers (input units 260). In the case of a plurality of players playing a game using a respective controller of each player included in one terminal device 20, it is assumed that the plurality of players are actually near each other.

### [1.5] Example of Social Game

In the present embodiment, the entertainment system may function as an SNS server which provides a communication-based service. The SNS server here may be an information processing device to provide a service which enables communication among a plurality of players.

In the present embodiment, if the entertainment system functions as the SNS server, a game called a “social game”, which is executed using a provided operation environment (e.g. application programming interface (API), platform) of the SNS, can be played.

Unlike conventional online games, a social game includes a game which does not require dedicated client software, and can be played on a Web browser and an SNS account alone. The present embodiment includes a configuration to connect with a terminal device 20 of another player via a network, and provide an online game which the players can share progress of the same game simultaneously online.

### [1.6] Example of Browser Game

In the present embodiment, a game played on a Web browser of the terminal device 20 may be provided. For example, browser games (games that startup merely by opening an installation site via the Web browser) created by various languages, such as HTML, FLASH (registered trademark), CGI, PUP, Shockwave, Java (registered trademark) applet, and Java Script (registered trademark), may be provided.

The terminal device 20 includes a Web browser which can read a Web page (HTML format data). In other words, the terminal device 20 performs display control using a communication control function to communicate with the server device 10, and data received from the server device 10 (e.g. Web data, data created in HTML format). The terminal device 20 also includes a Web browser function to send operation data by a player to the server device 10, and executes various processing to provide a screen to players so that the players can execute the game. The terminal device 20 may execute predetermined game processing by acquiring game control information provided by the server device 10, so as to execute the game based on the game processing.

Specifically, when the terminal device 20 requests the server device 10 to play a predetermined game, the terminal device 20 is connected to a game site of the server device 10 and the game is started. The terminal device 20 may have a configuration to use API when necessary, so that the server device 10 which functions as an SNS server performs predetermined processing, or executes the game by acquiring player information and the like managed by the server device 10 which functions as an SNS server.

### [1.7] Other

The entertainment system of the present embodiment may be constituted of one (device, processor), or may be constituted of a plurality of (devices, processors). The information stored in a storage area (later mentioned storage unit 170) of the server device 10, such as information on the player and game information, may be stored in a database (storage device, memory in a broad sense) connected via a network (intranet or Internet). The communication line between the terminal device 20 and the server device 10 may be wired or wireless.

### [2] SERVER DEVICE

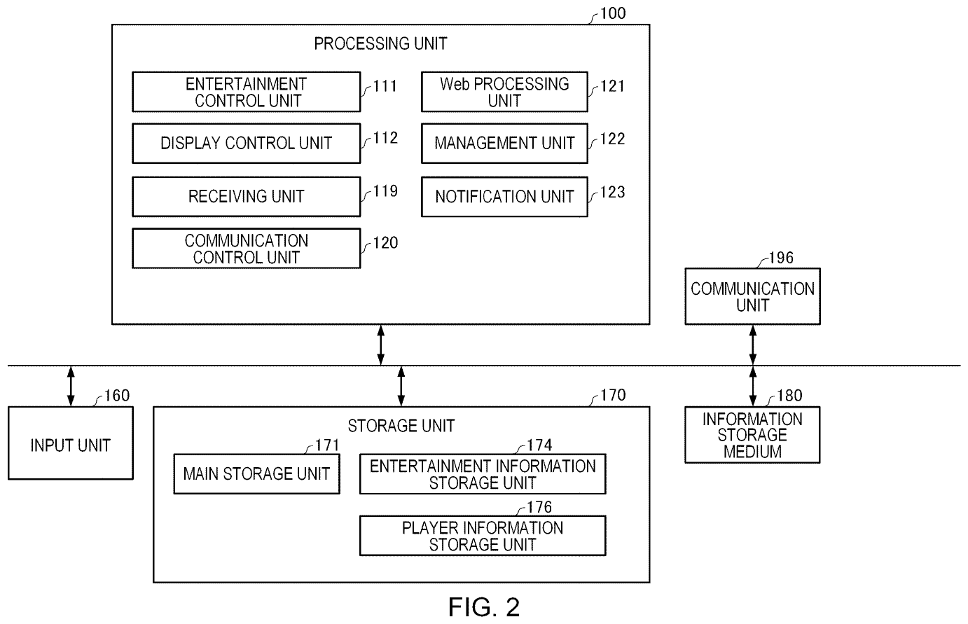

The server device 10 of the present embodiment will be described next with reference to FIG. 2. FIG. 2 is a functional block diagram of the server device 10 of the present embodiment. In the present embodiment, a part of the composing elements (each unit) in FIG. 2 may be omitted.

The server device 10 of the present embodiment includes: an input unit 160 which an administrator or the like uses for input; an information storage medium 180 in which predetermined information is stored; a communication unit 196 which communicates with the terminal device 20 and the like; a processing unit 100 which executes mainly processing related to a game to be provided; and a storage unit 170 which stores various data mainly used for the game.

The input unit 160 is used for a system administrator or the like to perform settings related to the game or other required settings, and to input data. For example, the input unit 160 of the present embodiment is constituted of a mouse, a keyboard, and the like.

The information storage medium 180 (computer-readable medium) is for storing programs and data, and the functions thereof are implemented by an optical disk (CD, DVD), magneto-optical disk (MO), magnetic disk, hard disk, magnetic tape, memory (ROM), or the like.

The communication unit 196 is for performing various controls to communicate with the outside (e.g. terminal, another server, another network system), and the functions thereof are implemented by various processors, such hardware as ASIC for communication, programs and the like.

The storage unit 170 is a work area for processing unit 100, the communication unit 196 and the like, and the functions thereof are implemented by RAM (VRAM) and the like. The information stored in the storage unit 170 may be managed in a database.

The storage unit 170 of the present embodiment includes: a main storage unit 171; an entertainment information storage unit 174 to store game information related to the game; and a player information storage unit (user information storage unit) 176.

The entertainment information storage unit 174 in particular stores information on virtual space (game field) where the entertainment content (e.g. game) is executed, information on the virtual camera, and set values used for the entertainment content, for example.

The player information storage unit 176 stores, for each player (for each user), player information (user information) associated with a player ID (user ID). The player ID is identification information to identify the player.

The processing unit 100 performs various processing using the main storage unit 171 in the storage unit 170 as a work area. The functions of the processing unit 100 are implemented by various processors (e.g. CPU, DSP), such hardware as ASIC (e.g. gate array), and programs.

The processing unit 100 performs various processing of the present embodiment based on the programs (data) stored in the information storage medium 180. In other words, the information storage medium 180 stores programs to cause the computer to function as each unit of the present embodiment (programs to cause the computer to execute processing of each unit).

For example, the processing unit 100 (processor) controls the server device 10 in general, based on the programs stored in the information storage medium 180, and performs various processing, such as controlling the transfer of data between each unit. Further, the processing unit 100 performs processing to provide various services in accordance with a request from the terminal device 20.

In the present embodiment, the server device 10 may execute a part or all of processing performed by the processing unit 100, or the terminal device 20 may execute a part of processing performed by the processing unit 100.

The processing unit 100 includes an entertainment control unit 111, a display control unit 112, a receiving unit 119, a communication control unit 120, a Web processing unit 121, a management unit 122, and a notification unit 123.

The entertainment control unit 111 performs various controls to provide a game (e.g. matchup game) of the present embodiment. For example, the processing unit 100 interlocks with the terminal device 20, and executes the game processing of the game provided to each user in the present embodiment, based on input by the player via the terminal device 20.

The processing unit 100 includes a timer function, and may be used to synchronize with each terminal device 20 to manage the progress of the game. In particular, the current time and the time set in advance may be outputted to each unit.

The entertainment control unit 111 executes game processing based on operation input by the player (operation information). For example, the entertainment control unit 111 receives operation input by the player (operation information) from the terminal device 20 of the player, and performs entertainment related processing. For example, the entertainment control unit 111 may perform the game processing. In the case of an online match, the entertainment control unit 111 performs matching processing and the like with each player.

The display control unit 112 controls a screen (image), which the server device 10 generated in accordance with the game situation, so as to be displayed on the display unit 290 of the terminal device 20. In other words, the display control unit 112 controls the display destination of the screen (image), which the server device 10 generated, to be the display unit 290 of the terminal device 20.

The display control unit 112 performs control for each player, so as to display a screen (game image, performance image) which is displayed on the terminal device 20 of each player.

The receiving unit 119 may receive information related to the game. For example, the receiving unit 119 may receive the content of the operation input from the terminal device 20.

The receiving unit 119 may receive input by the player, information related to the game, and the like, by data transmission/reception by the communication control unit 120.

The communication control unit 120 establishes connection (session) with the terminal device 20, and performs processing to communicate (transmit/receive) data via the network.

For example, the communication control unit 120 sends information related to the game to the terminal device 20 of the player. Further, from the terminal device 20 of the player, the communication control unit 120 receives the operation information inputted by the player which the terminal device 20 accepted. The communication control unit 120 also sends information related to the game to the terminal device 20.

The Web processing unit 121 functions as a Web server. For example, using a communication protocol such as HyperText Transfer Protocol (HTTP), the Web processing unit 121 performs processing to send data responding to a request of the Web browser installed on the terminal device 20, and processing to receive data which is sent by the Web browser of the terminal device 20.

The management unit 122 manages game information and player information, which is associated with the identifying information of the player, for each player.

The notification unit 123 notifies predetermined information to the player. “Notify” refers to notifying information to a player (terminal device 20 of the player). “Notify” may also be interpreted as “provide”, “present”, “display” or “send”.

The notification unit 123 may control transmission such that a screen is notified on the terminal device 20. In other words, the notification unit 123 may control such that the display control information on the screen (image) is generated, and the generated display control information is displayed on the terminal device 20 of the player (e.g. display unit 290 of the terminal device 20).

The server device 10 may include all or a part of the functions of the terminal device 20, which will be described below.

### [3] TERMINAL DEVICE

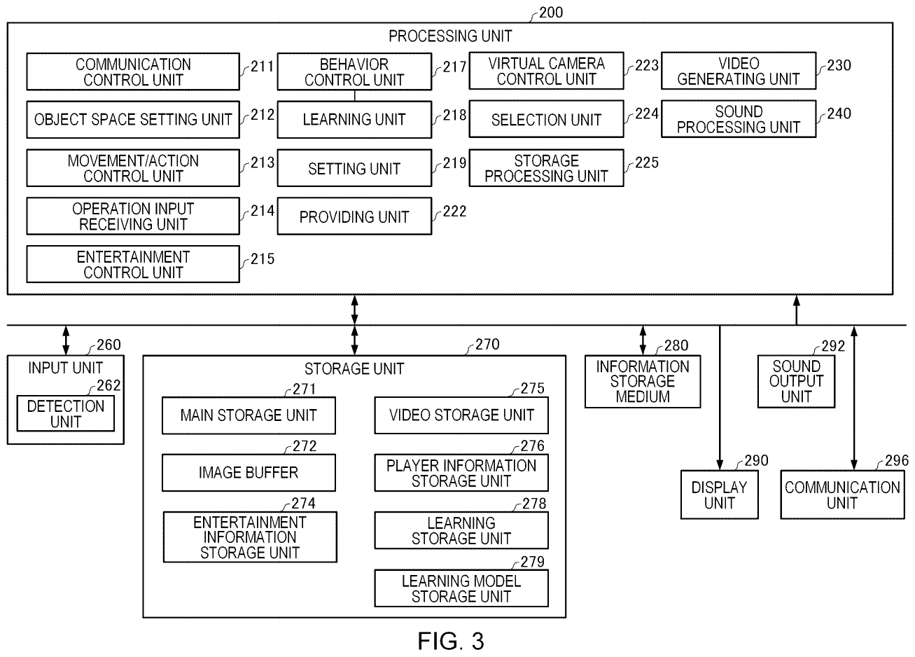

The terminal device 20 of the present embodiment will be described next with reference to FIG. 3. FIG. 3 is a functional block diagram illustrating an example of a configuration of the terminal device 20 according to the present embodiment. The terminal device 20 of the present embodiment may have a configuration where a part of the composing elements (each unit) in FIG. 3 is omitted.

An information storage medium 280 (computer-readable medium) is for storing programs, data, and the like, and the functions thereof may be implemented by an optical disk (CD, DVD), a magneto-optical disk (MO), a magnetic disk, a hard disk, a magnetic tape, a memory (ROM), or the like.

An input unit 260 includes buttons and levers to allow operation input (input of operation signals). The thermal device 20 performs processing related to entertainment while the player is viewing the screen of the entertainment content displayed on a display unit 290.

The input unit 260 may be implemented by a touch panel, a touch panel type display, or the like. In other words, the input unit 260 may include a detection unit 262 which can detect two-dimensional coordinates (x, y) of an instructed position on a screen where an image is displayed. For example, the input unit 260 includes the detection unit 262 which can detect two-dimensional coordinates (x, y) of a contact position on a contact detection area (touch panel). The contact operation on the display screen (hereafter called “touch panel” except in some cases) may be performed by fingertips or using an input device (e.g. stylus).

The input unit 260 may include a keyboard, a steering wheel, a microphone, an acceleration sensor, and the like.

A storage unit 270 is a work area of 200, a communication unit 296, and the like, and the functions thereof may be implemented by RAM (VRAM), or the like.

The storage unit 270 is a block diagram of an example of a storage area. The storage unit 270 of the present embodiment includes a main storage unit 271, an image buffer 272, an entertainment information storage unit 274, a video storage unit 275, a player information storage unit 276, a learning storage unit 278, and a learning model storage unit 279. Apart of these composing elements may be omitted, and the storage unit 170 of the server device 10 or a predetermined storage device connected via a network (cloud-based storage area) may constitute a part of the above configuration.

The main storage unit 271 is used as a work area. The image buffer 272 stores image data (display image) generated by a video generating unit 230. The image data generated by the server device 10 may be received and stored in the image buffer 272.

The entertainment information storage unit 274 stores entertainment information. For example, the entertainment information storage unit 274 stores game information. The terminal device 20 may receive game information from the server device 10, and store this game information in the entertainment information storage unit 274.

The game information includes command information and character information. The game information stored in the entertainment information storage unit 274 may include behavior information of the character, and information related to this behavior information. The game information stored in the entertainment information storage unit 274 may include information on a game field (game space), information on a virtual camera, character information, setting values used for the game, and the like.

The character information is information related to the character. For example, character information includes parameters of the character (e.g. physical strength value, offensive power, defensive power), items owned by the character (e.g. weapons), and a level (e.g. grade, rank) of the character. The level indicates the skill level and strength of the character. In the present embodiment, the level is sequentially updated on the basis of the result of the game.

The player information storage unit 276 stores information on the player. The terminal device 20 may receive player information corresponding to a player ID from the server device 10, and store this player information in the player information storage unit 276.

For example, the player information storage unit 276 stores a level of the player, history of play, tendency of play, information on other players related to the player, and the like.

The player information may also include operation input (operation information) of the player. The player information may not only include the player information associated with the player, but also include information on the game medium of the player (e.g. game media such as characters, cards and items owned by the player).

The learning storage unit 278 stores learning information. The learning storage unit 278 also stores evaluation information. Specifically, the learning storage unit 278 stores video (visual content including still and moving images). This video includes video generated by the video generating unit 230 of the present embodiment. This video may also include video generated by artificial intelligence (AI). The terminal device 20 may receive learning information from another information processing device, and store this learning information in the learning storage unit 278.

The learning model storage unit 279 stores a learning model (model). The learning model is a mathematical formula (function) that expresses a correlation (relationship) between input data and output data, and tendency thereof. The learning model storage unit 279 stores a learning model which was machine-learned by the learning unit 218.

The information storage medium 280 will be described. The information storage medium 280 can store programs to cause the computer to function as each unit of the present embodiment (progress to cause the computer to execute processing of each unit). The processing unit 200 performs various processing of the present embodiment based on the programs (data) stored in the information storage medium 280, as mentioned later.

The display unit 290 is a unit to output an image generated in the present embodiment, and the functions thereof may be implemented by a CRT, LCD, a touch panel type display, a head mounted display (HMD), or the like.

In the present embodiment, the display unit 290 is a touch panel display, so as to function as the input unit 260 as well for the player to perform game operation. The touch panel that can be used here may be a resistive film type (four-wire, five-wire), a capacitance type, an electromagnetic induction type, an ultrasonic surface acoustic wave type, or an infrared scan type touch panel.

The sound output unit 292 outputs sound generated by the present embodiment, and the functions thereof may be implemented by a speaker, a headphone, or the like.

The communication unit 296 performs various controls to communicate with the outside (e.g. server device 10, other terminal devices 20), and the functions thereof may be implemented by hardware (e.g. various processors, communication ASIC), programs, or the like.

The terminal device 20 may receive programs and data to cause the computer to function as each unit of the present embodiment, stored in the information storage medium 180 of the server device 10 and the storage unit 170, via a network, and store the received programs and data in the information storage medium 280 or the storage unit 270. The scope of the present invention may include such a case of receiving the programs and data and causing the terminal device 20 to function thereby.

A processing unit 200 (processor) interlocks with the server device 10, and performs such processing as entertainment control (e.g. game processing), image generating processing, and sound generating processing, based on the input data and programs received from the input unit 260.

The processing unit 200 also performs game processing (e.g. processing of matchup game) based on operation input by the player via the input unit 260. The processing unit 200 may execute interlocking with the server device 10, or a part or all of the processing unit 200 may be formed in the server device 10.

The processing unit 200 also performs various processing using the storage unit 270 as a work area. The functions of the processing unit 200 may be implemented by various processors (e.g. CPU, DSP), such hardware as ASIC (e.g. gate array), and programs.

The processing unit 200 includes a communication control unit 211, an object space setting unit 212, a movement/action control unit 213, an operation input receiving unit 214, an entertainment control unit 215, a behavior control unit 217, a learning unit 218, a setting unit 219, a providing unit 222, a virtual camera control unit 223, a selection unit 224, a storage processing unit 225, a video generating unit 230, and a sound processing unit 240. A part of these composing elements may be omitted.

The communication control unit 211 performs processing to send data to or receive data from the server device 10. The communication control unit 211 performs processing to store data received from the server device 10 to the storage unit 270, processing to analyze the received data, processing to control transmission/reception of other data, and the like.

In a case of controlling the entertainment content based on the information received from the server device 10, the communication control unit 211 receives information sent from the server device 10, and sends information on the terminal device 20 to the server device.

In a case of controlling the entertainment content with a terminal device 20 of another player, the communication control unit 211 receives information sent from the terminal device 20 of another player, and sends information on its own terminal device 20 to the terminal device 20 of the other player.

In the case of receiving an operation input to start communication from the player, the communication control unit 211 may communicate with another terminal device 20, or with the server device 10.

From the establishment of communication with another terminal device 20 or the server device 10 to disconnection of this communication connection, the communication control unit 211 performs processing to transmit/receive data with the other terminal device 20 or with the server device 10 at a predetermined cycle.

The communication control unit 211 performs processing to send identification information of the player and operation input to the server device 10, and receive data (e.g. Web page of player, screen) from the server device 10.

The communication control unit 211 may perform data transmission/reception with the server device 10 at a predetermined cycle, or may perform data transmission/reception with the server device 10 in a case where operation input is received from the input unit 260. In particular, the communication control unit 211 of the present embodiment may perform processing to receive a predetermined screen information (e.g. information on screen) from the server device 10.

In a case of a network system constituted of a plurality of terminal devices 20, the communication control unit 211 may execute communication control using a peer-to-peer (P2P) system which executes an online game while the plurality of terminal devices 20 performs data transmission/reception with each other, or may execute communication control using a client-server system which executes an online game while each terminal device 20 performs data (information) transmission/reception via the server device 10.

In the entertainment system of the present embodiment, data may be transmitted/received not only by wired communication, but also be wireless communication.

The object space setting unit 212 performs processing to dispose objects in an object space (virtual three-dimensional space). Besides characters, such display objects as a building, stadium, car, tree, post, wall and map (landscape) are also disposed in the object space. The object space here refers to a virtual game space where objects are disposed using three-dimensional coordinates (X, Y, Z), such as a world coordinate system and a virtual camera coordinate system.

For example, the object space setting unit 212 disposes objects (objects constituted of primitives, such as polygons, free curved surfaces, and sub-division surfaces) in a world coordinate system. Further, for example, the object space setting unit 212 determines a position and a rotation angle (orientation, direction) of each object in the world coordinate system, and disposes the object in the position (X, Y, Z) at the rotation angle (rotation angles around X, Y and Z axes).

The object space setting unit 212 may also perform processing to dispose instructing objects (e.g. input instructing object for special command, marker) on a screen (two-dimensional image, screen, screen coordinate system). The object space setting unit 212 may also dispose the instructing objects in an object space (three-dimensional space, world coordinate system, virtual camera coordinate system, model coordinate system).

The movement/action control unit 213 performs movement/action calculation for objects disposed in the object space. In other words, the movement/action control unit 213 performs processing to move an object in the object space, or to make an object act (motion, animation), based on the operation input received from the input unit 260, programs (movement/action algorithm), various data (motion data) and the like.

The movement/action control unit 213 controls movement/action of a character object (character), which is a main object, in the object space.

Specifically, using the key data based on the operation input to the input unit 260, the movement/action control unit 213 performs processing to control an action of a player character which the player operating the self-device is operating, processing to determine the hit of an attack technique performed by this character, and damage processing in the case of being attacked by an opponent character.

In a case where the opponent is an actual player, the movement/action control unit 213 acquires key data inputted via the terminal device 20 of the opponent, and performs movement and action of the attack technique performed by the opponent character, processing to determine the hit of this attack technique, and processing of movement and action of damage in the case of being attacked by the player character, and the like based on this acquired key data.

In a case where the opponent is a computer (CPU), the movement/action control unit 213 performs movement and action of the attack technique performed by the computer character (also called non-player character (NPC)), processing to determine the hit of this attack technique, and processing of movement and action of damage in the case of being attacked by the player character, based on a predetermined program and algorithm. In other words, in the case where the opponent is a computer, the movement and action of the computer character are controlled without being operated by the player.

In a case where the computer character is an AI character controlled by AI, the movement/action control unit 213 performs control of the movement and action based on the behavior inferred using a learning model.

The movement/action control unit 213 performs this control for each frame (e.g. every 1/60 second). The frame is a unit of time to perform the movement/action processing of objects and image generation processing.

The operation input receiving unit 214 receives an operation instructing command based on operation input which a player inputted via the input unit 260.

The entertainment control unit 215 controls, for example, processing to start the entertainment content (e.g. game) in a case where starting conditions are satisfied, processing to progress the entertainment content, processing to dispose objects (e.g. character, opponent character), processing to display objects, processing to calculate the result of the entertainment content (e.g. game result), and processing to end the entertainment content in a case where ending conditions are satisfied.

In a case where a player plays a matchup game with a computer, the entertainment control unit 215 progresses the game based on the information on the operation input by the

player received by the operation input receiving unit 214, and information controlled by the computer (e.g. information on the behavior determined by the behavior control unit 217).

In a case where actual players play a matchup game, the entertainment control unit 215 progresses the game in accordance with: the information on the operation input by a first player, which was received by the operation input receiving unit 214 of a terminal device 20A, and information on the operation input by a second player in a terminal device 20B, which was sent from the terminal device 20B of the second player.

The entertainment control unit 215 decreases the physical power values of both characters when these characters attack or defend each other, and determines the outcome (victory/defeat) based on the physical power values thereof.

The behavior control unit 217 performs processing to control a behavior (e.g. attacking, defending, acting) of a character. For example, the behavior control unit 217 controls behavior of an operation target character of the player (hereafter called “first character”), based on the operation input by the player.

The behavior control unit 217 may control a behavior of a computer character controlled by a computer (hereafter called “second character”) using learning data (e.g. learning model) learned by the learning unit 218 (e.g. machine learning).

The learning unit 218 learns (e.g. machine learning) about the video. For example, when the terminal device 20 inputs a predetermined input data, the learning unit 218 generates a model (learning model) to output a camera work (control information on the virtual camera) by machine learning.

The input data may be information on the entertainment content at this moment. For example, input data may be event information (type of event) at this moment, time from game start to this moment, event period, information on characters (avatars) that exist in the virtual space, sound information, image information, and the like. The input data may include information on camera work. By adding the pattern of the camera work to the learning data, the camera work can be predicted more accurately.

The setting unit 219 sets a learning frequency based on the information on the player. The setting unit 219 sets each weight for a plurality of items constituting the learning information respectively. In a case where each of these items has a different importance degree, setting a weight for each item respectively makes it possible to generate a more accurate video. The method for setting the weight may be adjusting the hyperparameter of the machine learning algorithm, or setting the verification index to measure the accuracy of specific items, for example.

The setting unit 219 may set the priority of each of the plurality of items of the learning information respectively, based on the operation input by the player.

The providing unit 222 performs processing to provide a video to a player. For example, the providing unit 222 performs processing to display a video on the display unit 290 of the terminal device 20.

The providing unit 222 may display a video received from the server device 10. The providing unit 222 may also display a display information or a screen using a Web browser.

The virtual camera control unit 223 performs processing to control a virtual camera (viewpoint) to generate an image viewed from a predetermined (arbitrary) viewpoint in an object space.

The virtual camera control unit 223 disposes at least one virtual camera in a virtual space. In other words, one virtual camera or two or more virtual cameras are disposed in the virtual space.

Specifically, in a case of generating a three-dimensional image, the virtual camera control unit 223 performs processing to control the position (X, Y, Z) of the virtual camera in the world coordinate system, and the rotation angle (e.g. rotation angle in the case of rotating clockwise viewed from the positive direction of each axis of the X, Y and Z axes).

In other words, the virtual camera control unit 223 performs processing to control at least one of the viewpoint position of the virtual camera, the line-of-sight direction, the angle-of-view, the moving direction, and the moving speed.

The selection unit 224 selects the video to be provided from a plurality of generated videos, based on the input information by the player.

The storage processing unit 225 performs processing to store the generated video in the video storage unit 275.

The video generating unit 230 performs drawing processing based on the result of various processing performed by the processing unit 200, generates an image thereby, and outputs the image to the display unit 290.

In other words, the video generating unit 230 generates video (visual content including still and moving images) as seen from the virtual camera in the virtual space.

The video generating unit 230 generates an image constituting the video as follows. For example, object data (model data) including vertex data (positional coordinates, texture coordinates, color data, normal vector, a value, and the like of a vertex) of each vertex of an object (model) is inputted to the video generating unit 230, where vertex processing (shading by a vertex shader) is performed on the basis of the vertex data included in the inputted object data. When the vertex processing is performed, vertex generating processing (tessellation, curved surface division, polygon division) to sub-divide polygons may be performed if necessary.

In the vertex processing, geometric processing, such as vertex moving processing, coordinate transformation (e.g. world coordinate transformation), visual field transformation (camera coordinate transformation), clipping processing, perspective transformation (projection transformation) and viewpoint transformation is performed in accordance with the vertex processing program (vertex shader program, first shader program), and the vertex data provided for the vertex group constituting the object is changed (updated, adjusted) on the basis of the processing result.

Then rasterization (scan conversion) is performed on the basis of the vertex data acquired after vertex processing, and the surface of the polygons (primitive) and pixels are corresponded. After the rasterization, pixel processing (shading by pixel shader, fragment processing) to draw pixels constituting the image (fragments constituting the display screen) is performed.

In the pixel processing, in accordance with the pixel processing program (pixel shader program, second shader program), various processing including reading texture (texture mapping), setting/change of color data, translucent synthesis, and anti-alias are performed, then the final drawing colors of the pixels constituting the image are determined, and the drawing colors of the object generated after the perspective transformation are outputted (drawn) to the image buffer 272 (a buffer to store image information in pixel units, such as VRAM, rending target, frame buffer).

In other words, in the pixel processing, per-pixel processing, to set or change the image information (e.g. color, normal line, brightness, a value) in pixel units is performed. Thereby an image viewed from the virtual camera (predetermined viewpoint) in the object space is generated.

The vertex processing and the pixel processing are implemented by hardware, which makes the drawing processing of polygons (primitives) programmable by the shader program written in shading language, that is, by a programmable shader (vertex shader, pixel shader).

In the case of the programmable shader, processing in vertex units or processing in pixel units becomes programmable, hence the content of drawing processing is highly flexible, and expressiveness can be greatly improved compared with a fixed drawing processing using conventional hardware.

In the case of drawing an object, the video generating unit 230 performs geometric processing, texture mapping, hidden surface removing processing, a blending processing, and the like.

In the geometric processing, coordinate transformation, clipping processing, perspective projection transformation, light source calculation, or the like, is performed for the object. Object data acquired after the geometric processing (after the perspective projection processing), that is, positional coordinates of the vertexes of the object, texture coordinates, color data (brightness data), normal vector, a value, or the like, is stored in the storage unit 270.

Texture mapping is processing to map the texture (texel values) stored in the storage unit 270 onto the object.

Specifically, texture (colors (RGB), such surface property as an a value) is read from the storage unit 270 using texture coordinates or the like, which is set (provided) for each vertex of the object. Then the texture (two-dimensional image) is mapped onto the object. In this case, processing to correspond pixels and texels, bilinear interpolation (interpolation for texels) and the like is performed.

For the hidden surface removal processing, hidden surface removal processing, based on a Z buffer method (depth comparison method, Z test) using a Z buffer (depth buffer) to store the Z values (depth information) of the drawing pixels, may be performed.

In other words, the Z values stored in the Z buffer are referred to when the drawing pixels, corresponding to the primitives of the object, are drawn. Then the Z values of the Z buffer, which were referred to, are compared with the Z values in the drawing pixels of the primitives, and if the Z values of the drawing pixels are Z values on the front side when viewed from the virtual camera (e.g. smaller Z values), then the Z values of the Z buffer are updated to new Z values, while drawing processing is performed on the drawing pixels.

“α blending (α synthesis)” refers to translucent synthesis processing based on the α value (A value) (normal a blending, added α blending, subtracted α blending, or the like).

For example, in the α blending, a drawing color (overwriting color) C1 which will be drawn in the image buffer 272, and a drawing color (underlayer color) C2 already drawn in the image buffer 272 (rending target), are linearly synthesized on the basis of the α value. In other words, if the final drawing color is C, C can be determined by C=C1*α+C2*(1−α).

The α value is information that can be stored in association with each pixel (texel, dot), and is additional information other than color information, for example. The α value may be used as masking information, translucency (equivalent to transparency or opacity), bump information, or the like.

In the case of playing a multiplayer online game, where data is transmitted or received from another terminal (second terminal) via a network, the video generating unit 230 performs processing to generate an image viewed from a virtual camera (virtual camera controlled by a terminal (first terminal)), which follows the movement of an operation target object of the terminal (first terminal). In other words, each terminal performs independent drawing processing.

In particular, in the present embodiment, the video generating unit 230 may generate a video based on the learning information related to the video. The learning information related to the video includes evaluation information related to this video.

In other words, the video generating unit 230 inputs data to a model of which training has been completed (learned model), and generates (outputs) a new video.

The data to be inputted is new data inputted to a learned model which completed learning based on the learning information, and by provided new input data, the model can perform prediction. In other words, the learning information is a data set to train the model, and the data to be inputted to the model, which completed training, becomes data to perform prediction using the result of learning by the model.

The sound processing unit 240 performs sound processing based on the result of various processing performed by the processing unit 200, generates such game sounds as BGM, sound effects and voice, and outputs the game sound to the sound output unit 292. The sound processing unit 240 may perform processing that is the same as all or a part of the processing performed by a sound processing unit 140 of the server device 10.

The terminal device 20 of the present embodiment may control game play in single player mode, in which only one player can play the game, or in multiplayer mode, in which a plurality of players can play the game. For example, in the case of controlling play in multiplayer mode, game processing may be performed by transmitting data to or receiving data from other terminal devices 20 via a network, or one terminal device 20 may perform processing based on operation inputs from a plurality of input units.

In a case where the terminal device 20 of the present embodiment plays a game with a plurality of terminal devices 20 via P2P, or the like, one terminal device 20 may play the role of host, and execute processing. In such a case, the terminal device 20, which plays the role of host, may perform processing of each processing unit (a part or all of the processing units) of the server device 10.

The terminal device 20 of the present embodiment may perform the same processing as the server device 10, and display a screen on a display unit of this terminal device 20.

### [4] OVERVIEW

The entertainment system of the present embodiment provides generated video in the entertainment content executed in a virtual space.

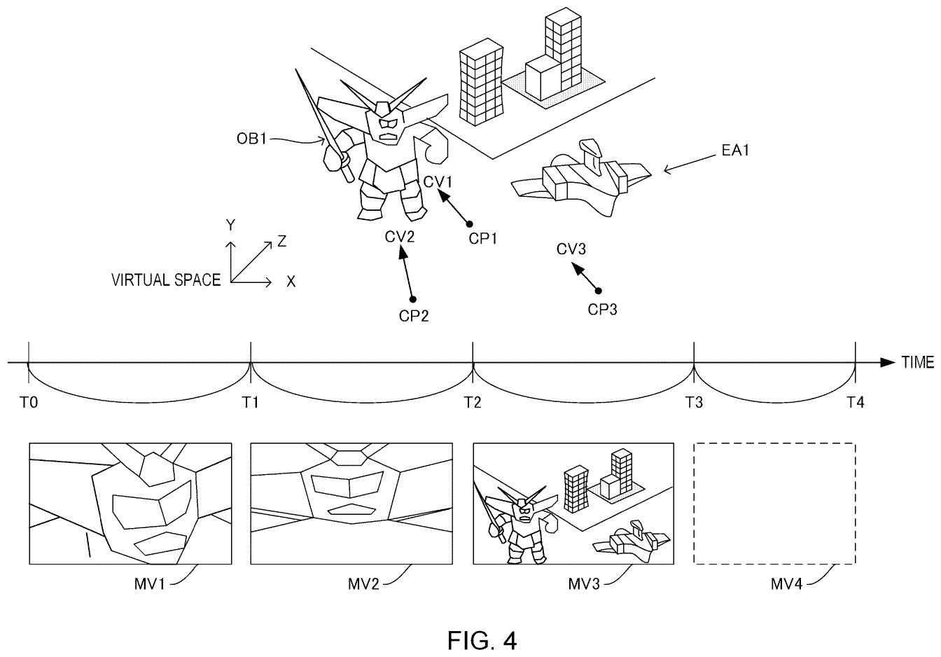

For example, the entertainment system disposes at least one virtual camera in the virtual space. Then, as illustrated in FIG. 4, the entertainment system provides a player (user) with the first cut video MV1 generated in the virtual camera. Then the entertainment system provides the player with a second cut video MV2 generated in the virtual camera. Then the entertainment system provides the player with a third cut video MV3 generated in the virtual camera.

For example, in the first cut video MV1, the virtual camera is set such that the distance between a character OB1 and the position of the virtual camera (viewpoint) becomes within 2 m in the period from T0 to T1, and the character OB1 is captured from the front at a short distance. For example, the viewpoint of the virtual camera is set at a position CP1 at a predetermined timing in the period from T0 to T1, where the line-of-sight direction of the virtual camera is set to a direction CV1, and an image viewed from the virtual camera is generated.

For example, in the second cut video MV2, the virtual camera is set such that the distance between the character OB1 and the position of the virtual camera (viewpoint) becomes within 2 m in the period from T1 to T2, and the character OB1 is captured from the lower front at a short distance. For example, the viewpoint of the virtual camera is set at a position CP2 at a predetermined timing in the period from T1 to T2, where the line-of-sight direction of the virtual camera is set to a direction CV2, and an image viewed from the virtual camera is generated.

In the third cut, the virtual camera is set at a position more distant from the character OB1 compared with the first and second cuts in the period from T2 to T3, and the character OB1 and a character EA1 (opponent character) are captured as subjects. For example, the virtual camera is set such that the distance between the character OB1 and the position of the virtual camera (viewpoint) becomes 10 m or more. For example, the viewpoint of the virtual camera is set at a position CP3 at a predetermined timing in the period from T2 to T3, where the line-of-sight direction of the virtual camera is set to a direction CV3, and an image viewed from the virtual camera is generated.

The entertainment system of the present embodiment learns information related to the virtual camera. For example, information related to the virtual camera which generated each of the first to third cut videos MV1, MV2 and MV3 is learned.

Then, as illustrated in FIG. 4, the entertainment system controls the virtual camera based on the learning information in a fourth cut period (period from T3 to T4), and generates the fourth cut video MV4 viewed from the virtual camera.

In particular, in the present embodiment, the fourth cut video MV4 is generated on the basis of the evaluation information of each of the first to third cut videos MV1, MV2 and MV3. For example, in a case where the evaluation of MV1 is high, the distance between the character OB1 and the position of the virtual camera (viewpoint) is within 2 m, hence the character OB1 is captured from the front direction in the fourth cut. Further, the position of the virtual camera is determined such that the distance between the character OB1 and the position of the virtual camera (viewpoint) becomes within 2 m. In this way, according to the present embodiment, a new video MV4 is automatically generated considering the evaluation of the previous videos, and provides the new video MV4 to the user. Therefore, the video MV4 having a high user satisfaction can be provided.

### [5] DESCRIPTION OF VIDEO GENERATION

The term “video” includes both “moving images” and “still images”. In other words, “video” refers to a plurality of images that are sequentially displayed over time. Video generation refers to generating each of the individual images that constitute the video.

In the present embodiment, the virtual camera is disposed in the virtual space (also called “three-dimensional virtual space” or “game space”), and images viewed from the virtual camera are generated. For example, images are generated on the basis of a frame rate (e.g. 60 fps (frames per second)).

In the present embodiment, one cut (predetermined period) of the length of a video is generated. The length of one cut indicates the length of time of the video. The length of one cut in the present embodiment is about 5 to 10 seconds, but may be 10 seconds or more, or less than 5 seconds.

### [6] DESCRIPTION OF VIDEO GENERATION BY AI

In the present embodiment, video content (visual content including still and moving images) is generated by AI (e.g. deep learning). Note that AI stands for artificial intelligence.

For example, the entertainment system of the present embodiment learns such parameters as a position of a virtual camera disposed in the virtual space, and a position of a character.

Since the position of the character, position of the virtual camera, and the like, have been learned, AI generates a video with determining the appropriate viewpoint in a scene, an appropriate subject, appropriate composition, appropriate camera work, and the like.

### [7] LEARNING INFORMATION

In the case of generating a video by AI, “learning information” refers to data and knowledge required for AI to generate the video. Learning information includes still images, moving images, language information such as text and voice, and numeric information on physical laws and light sources.

Further, in order to generate an image viewed from the virtual camera in the virtual space using AI, information on three-dimensional models, poses, and the like is required as the learning information. Using a data set that includes this information, AI can learn the information on three-dimensional models, poses, and the like, and generate an image viewed from the virtual camera in the virtual space thereby.

In particular, the entertainment system of the present embodiment learns information related to the video. The learning information is, for example, the subject, composition, performance content of an event, and the like.

The learning information includes information related to the virtual camera. The information related to the virtual camera includes the viewpoint (position) of the virtual camera, orientation (line-of-sight direction), viewing angle of the virtual camera, and the like.

The information related to the virtual camera also includes a type of virtual camera (e.g. telephoto lens, fisheye lens, closer-range camera), the switching timing of the virtual camera, and the like.

The switching timing of the virtual camera is a timing of switching from the video of the Nth cut (e.g. the first cut) to the video of the (N+1)th cut (e.g. the second cut).

The information related to the virtual camera also includes a moving method of the virtual camera. The moving method includes panning (horizontal movement), tilting (vertical movement), moving information on movement linking with a subject (e.g. character), moving information of the virtual camera on approaching or departing the subject (dolly in, dolly out), and information on camera shake of the virtual camera.

The information related to the virtual camera also includes information related to a change of angle-of-view (zoom in, zoom out).

The learning information also includes image information. The image information includes information related to an object (model) (e.g. positional coordinates of vertexes, texture coordinates, color data, normal vector, α value). The image information also includes effect information, texture information, blur information, and information on translucent synthesizing processing. The image information also includes information on the image in pixel units (e.g. color, normal line, brightness, α value). The image information also includes environmental information (information on light source, shadow, weather (e.g. rain, snow), day/night).

The learning information includes information related to a subject of the virtual camera. The information related to a subject is, for example, information on a character of the subject (e.g. character name, character ID and number of characters of player characters and opponent characters (enemy characters)).

In the case where the subject is a character, the information related to a subject includes the shape and structure of an object (three-dimensional model) of the character, and information on the texture and pose of the character.

The information related to a subject may include an occupancy ratio of the subject on the screen. For example, in each image of a video (video provided in a period of a first cut), an occupancy ratio of a subject (character OB1) that is displayed on the screen is calculated, and an average occupancy ratio in this video period is calculated. For example, in the first cut, the occupancy ratio is 80% since the character OB1 is displayed close up, and in the third cut, the occupancy ratio is 20% since the character OB1 is captured from a distance, that is, the occupancy ratio may be different depending on each video.

Information related to a subject may include information on the light source that illuminates the subject (position and orientation of light source). The light source may be the sun or a light in the virtual space or a light source to illuminate the subject to prevent illuminating the subject from behind.

The learning information includes information related to the game situation. The information related to the game situation includes input information (operation information) by the player.

For example, the information related to the game situation includes information on whether the player character (player operated by player) is on the offensive side in the game situation, whether the player character is being attacked in the game instruction, whether the player character is on the defensive side in the game situation, or the like. The information related to the game situation also includes parameter information, such as offensive power, defensive power and physical power of the player character and enemy character (opponent character) respectively.

The learning information includes information related to image analysis. The information related to image analysis may be image information or may be information acquired by analyzing the generated image. For example, the information related to the image analysis is information (lightness) and effect information for each pixel of the generated image.

The image related to image analysis includes information indicating which characters and the number of characters captured in the image.

For example, the information related to image analysis may be a result of loading a predetermined reference video (e.g. animation video, live action video), and analyzing the generated image by comparing this image with the reference video (e.g. degree of matching).

The learning information may include learning information of other players. For example, learning information when a public figure (e.g. famous manager, famous game player, champion of an E sport) who operated and generated a video may be set in advance (preset), and downloaded.

The learning information may also include information on an event (performance) (e.g. identification information, start time, event period) and music information.

The learning information of the present embodiment must be digitized so that it can be processed by AI. “Digitized” means converting non-numeric data (e.g. character strings, images) into numeric data, for example. In the case of digitizing an image, the color and lightness of each pixel of the image is converted into a numeric value. In the case of digitizing text, each word or character of the text is converted into a numeric value. In the case of digitizing sound, the waveform or frequency of the sound is converted into numeric values.

### [8] EXAMPLE OF LEARNING INFORMATION

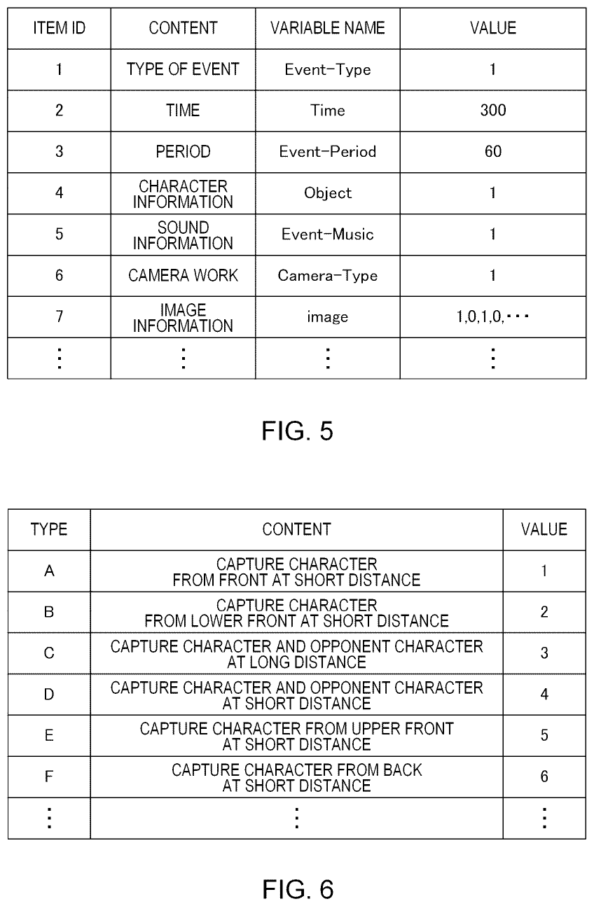

FIG. 5 illustrates an example of the learning information. The learning information includes a plurality of items (plurality of elements). Each item is associated with a variable name and its value.

The learning information includes an item of an event (performance content). A variable name of this item is “Event-Type”. In the present embodiment, a numeric value is determined in advance in accordance with the type of event. The numeric value is set for the variable. For example, in a case of an event where an ordinary enemy is attacked with a sword, “1” is set. In a case of an event where an ordinary enemy is attacked by a bean gun, “2” is set. In a case of an event where an enemy boss is attacked, “3” is set.

The learning information also includes an item of time (period), which indicates the elapsed time from the game start point to a predetermined point of the event (e.g. start point of the event). A variable name of this item is “Time”, and in a case where the start point of an event where an ordinary enemy is attacked with a sword (Event-Tyep=1) is a point when 300 seconds have elapsed from the game start point, “300” is set for “Time”.

The learning information also includes an item of the event period. A variable name of this item is “Event-Period”. For example, in a case where in an event period when an ordinary enemy is attacked with a sword (Event-Tyep=1) is 60 seconds, “60” is set for “Event-Period”.

The learning information also includes an item of a character to be a subject in the event. A variable name of this item is “Object”. In a case of a character OB1, “1” is set, in a case of a character OB2, “2” is set, and in a case of a character EA1, “3” is set. For example, in a case where a character to be a subject is character OB1, “1” is set for “Object” of the variable. A plurality of values are set if there are a plurality of subjects.

The learning information may also include music information in an event. A variable name of this item is “Event-Music”. In the present embodiment, a type of BGM is digitized, and the value of the BGM outputted in the event is set for the variable. For example, in the case where BGM is the “OO's Theme”, “1” is set as the numeric value, and in the case where BGM is the “OO March”, “2” is set as the numeric value.

The learning information also includes a type of camera work of the virtual camera. A variable name of this item is “Camera-Type”. In the present embodiment, a type of camera work is digitized, and the value of the camera work used in the event is set for the variable.

FIG. 6 illustrates a relationship between a type of camera work and a value.

Type A of the camera work indicates capturing a character from the front at a short distance (e.g. distance between the virtual camera and the character is within 2 m). For example, a value of type A of the camera work is “1”.

Type B of the camera work indicates capturing a character from the lower front at a short distance (e.g. distance between the virtual camera and the character is within 2 m). For example, a value of type B of the camera work is “2”.

Type C of the camera work indicates capturing a character at a long distance (e.g. distance between the virtual camera and the character is 10 m or more). For example, a value of type C of the camera work is “3”.

Referring back to FIG. 5, the learning information also includes image information. A variable name of this item is “Image”. In the present embodiment, such information as a pixel value and lightness is digitized and set in pixel units.

In the learning information of the present embodiment (e.g. learning information as image information), numeric values may be set in a predetermined format, such as in an array and a matrix. Further, in the present embodiment, a video ID to identify the video, and learning information ID to identify the learning information corresponding to the video, are assigned in video units.

The entertainment system may generate a data set based on the learning information. The data set is a set of specific images and data used for learning.

### [9] EVALUATION INFORMATION

The entertainment system of the present embodiment acquires evaluation information associated with a video, and stores the evaluation information in the learning storage unit 278. The video is associated with the learning information. Hence there is a correspondence between the learning information and the evaluation information. In a wide sense, it can be interpreted that the learning information includes the evaluation information.

The evaluation target video in the present embodiment may be a video generated without using a learning model (e.g. video generated by input information by the player or by computer control), or video generated using a learning model

The evaluation information may be an evaluation information on the video based on the input by the player. For example, the evaluation information may be evaluation evaluated in the 1 to 5 value range. Here as the numeric value is higher, the evaluation is higher. The evaluation information may be a number of evaluation indicators (e.g. “likes”) corresponding to the video.

For example, when a video is generated in realtime when a player is playing a game, it is assumed that the player is absorbed in viewing the video in a case where the player does not operate the game. Therefore the evaluation of this video is determined as “high” if no input is received from a player while providing the video. For example, the evaluation value “5” is set for this video. In a case where a predetermined input (e.g. input on cancellation, input on operation unrelated to playing game) from the player is detected while providing a video, on the other hand, evaluation of this video is determined as “low”. For example, the evaluation value “1” is set for this video.

The evaluation information may be evaluation information on the video provided by a plurality of players. The evaluation information provided by then plurality of players may be regarded as a “big data”. In other words, the evaluation information may be statistical data of evaluation by a plurality of players in a global Internet environment. For example, an average value of the evaluation values provided by a plurality of players is calculated for a predetermined video, and this calculated average value is set in association with this video.

The evaluation information may be difference information between a video and a predetermined reference video. The reference video is a video to be a reference, such as an animation video, live action video, and a computer graphics (CG) video. For example, it is assumed that a game of the present embodiment can execute a game based on a specific animation (e.g. game based on a world view of an animation), and a generated video is a video that reproduces a famous scene of this animation video. In this case, difference information (e.g. level of difference, degree of matching) between this generated video and the original animation video is determined, and this difference information is used as the evaluation information.

For example, it is assumed that the character OB1 is captured from the lower front direction in a scene of the animation video, but the character OB1 is captured from the front direction in the scene of the generated video. In this case, it is determined that the difference is major. If the character OB1 is also captured from the front direction in the scene of the generated video, on the other hand, it is determined that the difference is minor. The value of evaluation is set to high if the difference between the generated video and the animation video is minor, and is set to low if this difference is major.

In the case of calculating the degree of matching between the generated video and the animation video, the value of evaluation is set higher as the degree of matching is higher.

The entertainment system may acquire evaluation information corresponding to the video from a predetermined information processing device (e.g. information processing device of a distribution site) connected via the Internet.

The evaluation information may be information digitizing admiration and support from the viewers (e.g. players) viewing the video through the distribution site via an application and Web site (e.g. total amount of “social tipping” for the video, a number of “likes”) or a number or viewers.

In the present embodiment, a timing of acquiring the learning information for the video and a timing of acquiring the evaluation for this video may be different.

For videos receiving high evaluation from players, among the AI generated videos provided to players, the entertainment system adjusts the parameters of the learning model based on this evaluation, so as to increase AI accuracy.

### [10] STORING EVALUATION INFORMATION

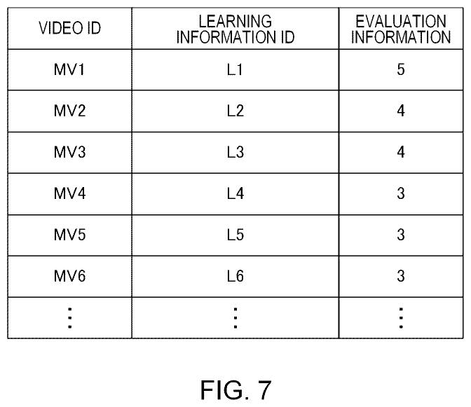

FIG. 7 illustrates an example of a correspondence between a video ID, a learning information ID, and evaluation information. In the present embodiment, the video ID, the learning information ID and the evaluation information are stored in the learning storage unit 278. On the basis of this stored information, such information as the correspondence between a camera work and evaluation by the player can be acquired.

Then when a video is generated by AI, optimum learning information in the current situation can be searched, a video highly evaluated by a player can be generated. For example, if the player selects a subject for a player character and evaluates this as highest when the video generated by camera work captures the player character at a short distance, a new video is generated by this camera work.

If the player evaluates a video generated by AI as low, this low evaluation is stored and associated with this video. This information is used when the video is generated by AI the next time.

### [11] VIDEO GENERATION BASED ON EVALUATION INFORMATION

The entertainment system of the present embodiment generates a new video based on the evaluation information (learning information in a wide sense) for the video.

For example, in a case where an event of attacking an ordinary enemy with a sword is generated, the entertainment system searches a camera work when a video was generated in a situation similar to this event generation.

A degree of matching may be calculated for each item of the learning information, and camera work of which degree of matching is 70% or more may be searched. Then a camera work having the highest evaluation value is selected out of the searched camera works. Then using this selected camera work, a video of an event of attacking an ordinary enemy with a sword is generated.

A concrete example will be described. In a case where an event of attacking is generated at timing TO, and then a video MV4 is generated by AI at timing T3, as illustrated in FIG. 4, for example, control is performed as follows.

In other words, the entertainment system generates a new video based on the learning information. For example, at timing T3, videos MV1, MV2 and MV3, associated with the already learned learning information, exist. In the present embodiment, it is assumed that the evaluation value of the video MV1 is “5”, the evaluation value of the video MV2 is “4”, and the evaluation value of the video MV3 is “4”. In this case, according to the present embodiment, a new video is generated on the basis of the learning information of the video MV1 having the highest evaluation value.

For example, in the new video generation step, a camera work, where the distance between the virtual camera and the character is within 2 m and the character is captured from the front, is used, and a new video MV4 is generated thereby. Then the player can enjoy a satisfactory video.

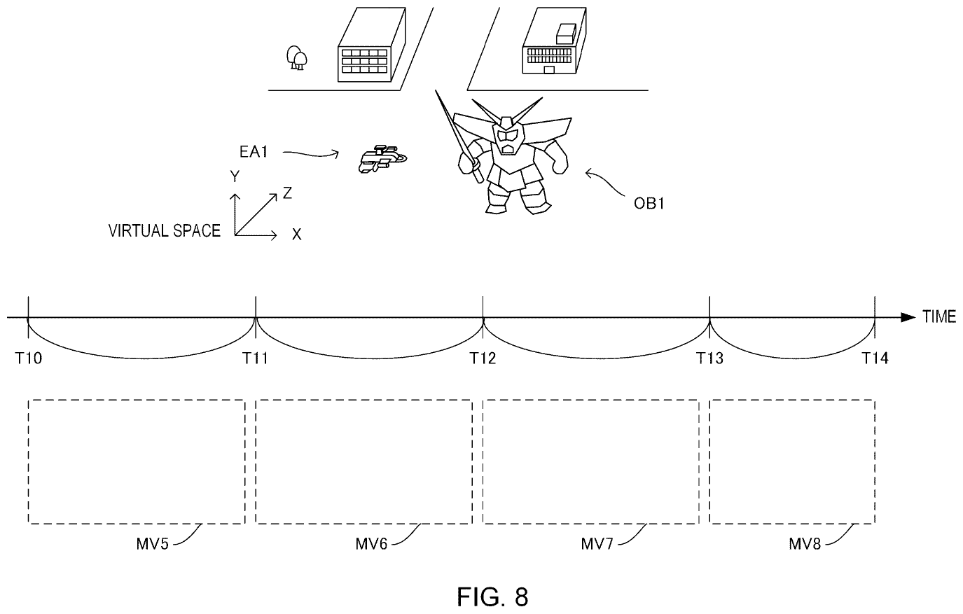

In a case where an attack event constituted of a four-frame video MV5 to MV8 is generated, as illustrated in FIG. 8, the entertainment system generates: the video MV5 (video in period from T10 to T11), the video MV6 (video in period from T11 to T12), the video MV7 (video in period from T12 to T13), and the video MV8 (video in period from T13 to T14).

In the present embodiment, a new video is generated on the basis of the learning information. For example, in the attack event already performed, the videos MV1, MV2, MV3 and MV4, which are associated with the already learned learning information, exist. The evaluation value of the video MV1 is “5”, the evaluation value of the video MV2 is “4”, the evaluation value of the video MV3 is “4”, and the evaluation value of the video MV4 is “3”.

Then according to the present embodiment, the video MV5, the video MV6, the video MV7 and the video MV8 are generated on the basis of the learning information of the video MV1 having the highest evaluation value.

In the case where videos having the same evaluation value “5” exist, a new video is generated on the basis of the learning information of at least one video.

### [12] SELECTION OF VIDEO

The entertainment system of the present embodiment may select a video to be provided, out of a plurality of generated videos, based on the input information by the player.

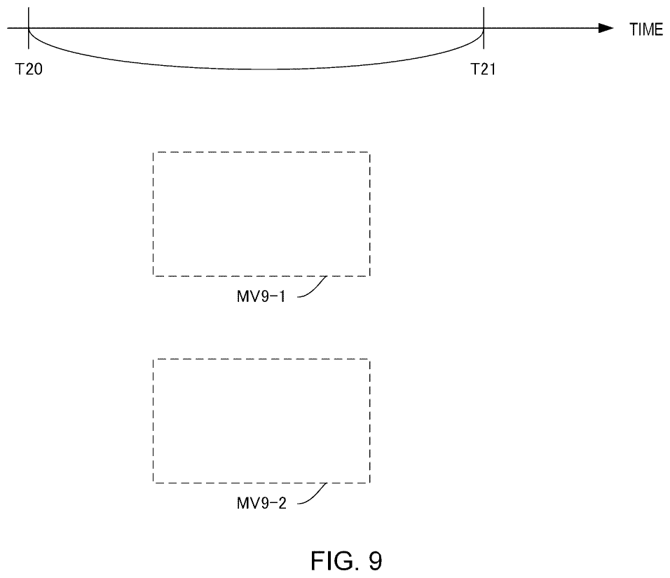

For example, a case where an attacking event constituted of one frame of video MV9 is generated will be described. In this case, as illustrated in FIG. 9, the entertainment system may generate a plurality of videos corresponding to the period from T20 to T21. In other words, by using the learning information of a video having the highest evaluation (e.g. video MV1), out of the videos associated with the learning information, two types of videos MV9-1 and MV9-2 may be generated as videos corresponding to the period from T20 to T21.

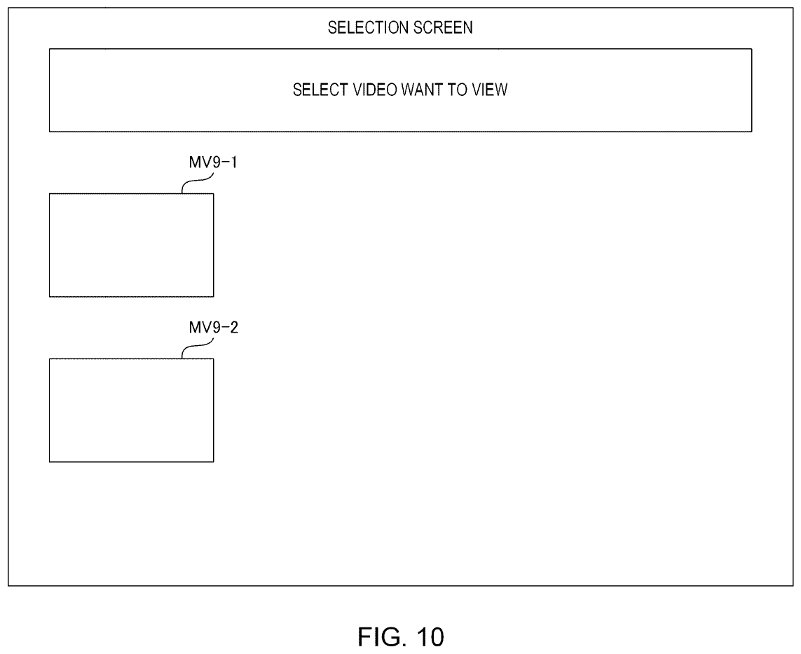

The entertainment system may receive the selection of one video to be provided to (displayed for) the player, out of the plurality of videos, based on the input information by the player, as illustrated in FIG. 10. For example, thumbnail images of the videos MV9-1 and MV9-2 are displayed as candidates of the video to be provided. Then based on the input information by the player, the selected video is provided. For example, in a case of receiving the selection of the video MV9-1 by the player (e.g. a case of receiving an input of clicking on the thumbnail image of video MV9-1), the video MV9-1 is displayed on the terminal device 20 of this player.

In a case where an attack event constituted of four frames of videos MV10, MV11, MV12 and MV13 are generated, the entertainment system controls as follows.

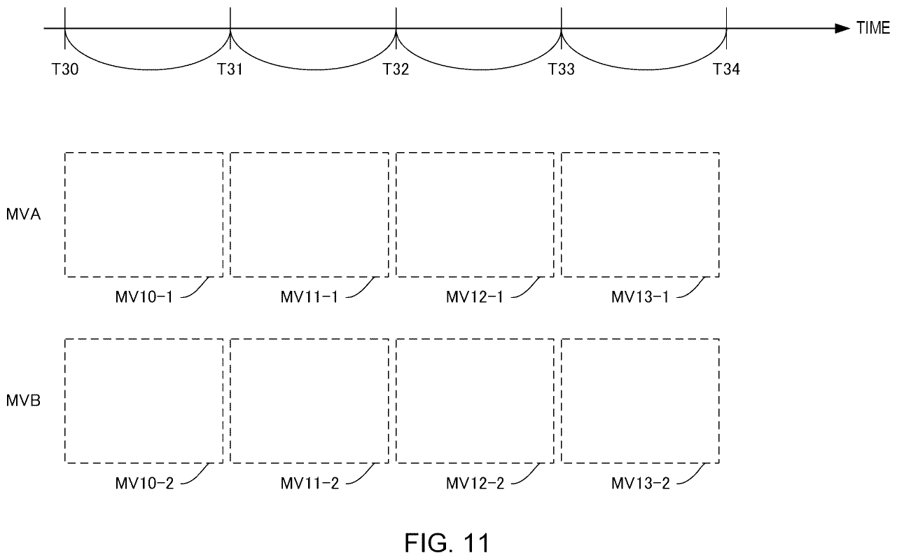

That is, as illustrated in FIG. 11, the entertainment system may generate a plurality of types of videos. For example, two types of videos MVA and MVB are generated on the basis of the learning information of a video having the highest evaluation (e.g. video MV1), out of the videos associated with the learning information.

In other words, in the present embodiment, a series of video MVAs (video in period from T30 to T34) constituted of video MV10-1 (video in period from T30 to T31), MV11-1 (video in period from T31 to T32), MV12-1 (video in period from T32 to T33), and MV13-1 (video in period from T33 to T34) are generated. Further, a series of video MVBs (video in period from T30 to T34) constituted of video MV10-2 (video in period from T30 to T31), MV11-2 (video in period from T31 to T32), MV12-2 (video in period from T32 to T33), and MV13-2 (video in period from T33 to T34) are generated.

The entertainment system may receive the selection of one video to be provided to (displayed for) the player, out of a plurality of videos, based on the input information by this player. For example, thumbnail images of the video MVA and the video MVB are displayed as candidates of the video to be provided, then if the selection of the video MVA is received on the basis of the input information by the player, the video MVA is displayed on the terminal device 20 of this player.

The entertainment system may perform learning based on the video selected by the player. In other words, parameters or the like of the learning model may be adjusted. In this case, when a video captured with a type A camera work (camera work to capture a character at a short distance) is selected many times by the player, for example, AI can make the adjustment to generate a video with the type A camera work.

### [13] EXAMPLE OF PROVIDING VIDEO

### [13.1] Example of Providing Video Related to Game Content

An example of the entertainment system of the present embodiment will be described. For example, the entertainment system may be a game system of a simulation RPG (role playing game), where based on an event generated in a first virtual space in which a character (character object) is disposed, the character performs in a second virtual space.

In other words, the entertainment content is a service, performance, video and the like of this game

Specifically, in a simulation part (also called “first part” or “game part”), this game system provides a first virtual space for the character to move, and in a performance part (also called “second part”), this game system provides a second virtual space to perform rendering. The first virtual space and the second virtual space exist independently from each other.

For example, it is assumed that an event of the operation target character OB1 of the player attacking an enemy character EA1 is generated in the first virtual space. In this case, this game system moves from the simulation part to the performance part, and provides a video to the player. In the present embodiment, in the performance part, a video viewed from the virtual camera is generated on the basis of the learning information related to the virtual camera.

### [13.2] Video to Capture an Avatar in Metaverse

The entertainment system may be an event (e.g. theatrical event) generated in a metaverse (virtual space), in which an avatar (alter ego) of the player is disposed.

Metaverse refers to a virtual pace on the Internet. In the virtual space, users can communicate with each other. The virtual space in the metaverse can be accessed using such a device as virtual reality (VR) goggles, augmented reality (AR) glasses, or the like. The user can enjoy various services and contents using an avatar, which the user created as an image alter ego themself.

In other words, the entertainment content may be a service to enjoy the action of the avatar in the virtual space, event, video, and the like.

For example, the avatars of a plurality of players are disposed in the virtual space respectively. In the event of a play, a part is assigned to each avatar, and each avatar acts in accordance with the assigned part in the virtual space.

Then a virtual camera is disposed in the virtual space, and the virtual camera captures the play viewed in the virtual space, and provides the captured video to each player.

On the basis of the learning information corresponding to the video, the entertainment system controls the virtual camera. For example, in the case of performing a play about Snow White, a video is generated in the scene of giving a poisoned apple to Snow White, based on the learning information having the highest evaluation value.

For example, in a case where a video of camera work of an avatar subject playing the role of an old woman holding a poisoned apple has low evaluation, and a video of camera work of an avatar subject playing the role of Snow White receiving the poisoned apple has high evaluation, the video is generated with the camera work of the avatar subject playing a part of Snow White receiving the poisoned apple.

In a scene where Snow White eats the poisoned apple, it may be generated such that a video in which Snow White is always the subject, the line-of-sight direction is toward the mouth of Snow White, and predetermined values are used for the angle-of-view, and the like. The entertainment system may learn the learning information for a scene which requires this special camera work.

Further, in the metaverse, the learning information on the action of the avatar may be learned so that the action of the avatar is controlled on the basis of the learning information. In other words, the action of the avatar may be controlled using a learned mode of which learning was performed on the basis of the learning information on the action of the avatar.

### [14] FLOW CHART

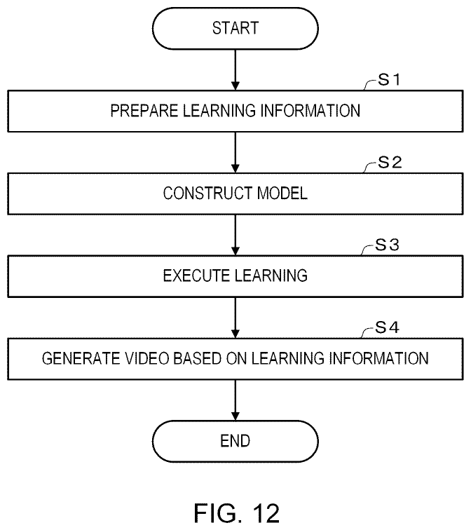

The flow of the video generation processing by AI according to the present embodiment will be described next with reference to FIG. 12.

First learning information is prepared (step S1). For example, learning information corresponding to a previously generated video is provided and stored in the learning storage unit 278. For example, a type and features of an image to be generated are collected from information on the images of generated videos (e.g. video MV1, MV2 and MV3), and stored in the learning storage unit 278.

Then a model is constructed (step S2). On the basis of the learning information stored in the learning storage unit 278, a model (learning model) is generated. A “model” is a tool to analyze the learning information and extract information required to generate videos (generate images). This model is normally generated using a neural network.

The learning is executed (step S3). In other words, based on the generated model, learning is executed. “Learning is executed” refers to inputting the learning information into a model and causing the model to reflect patterns based on the learning information. By repeating this learning, the accuracy of the model is increased.

Then based on the learning information, a video is generated (step S4). In other words, a new video is generated using the learning model. As learning progresses, a more accurate video can be generated. Processing ends here.

### [15] INFORMATION PROCESSING DEVICE

In the present embodiment, in the case of providing a video based on machine learning, the entertainment system mainly implements the learning function and inference function. However an information processing device (e.g. terminal device 20, server device 10), which is a composing element of the entertainment system, may have the learning function and the inference function (prediction function).

### [16] LEARNING PERIOD

In the present embodiment, a learning model that learned information related to a video displayed by the player while playing the entertainment content, is generated, but a video may also be generated using this learning model. In other words, a part or all of the learning period and the play period of the entertainment content may overlap.

Further, a learning period may be set in advance, so that learning data related to the displayed video is collected while the player is playing the entertainment content, and a learned model is generated using this information. Then using this learned model, a video may be generated in a game play period which is different from the learning period. In other words, in this case, the learning period and the play period of the entertainment content do not overlap.

### [17] MACHINE LEARNING

The entertainment system of the present embodiment generates a new video by inputting learning information related to a video into a neural network or a machine learning algorithm.

In the case of performing machine learning to generate a video, either one of the supervised learning or unsupervised learning may be used.

In the case of performing machine learning to generate a video, the supervised learning or unsupervised learning is selected, depending on the purpose and the available data.

The supervised learning is used in a case where the data is labeled. The unsupervised learning, on the other hand, is used in a case where the data is unlabeled. For example, in a case where a plurality of similar images exist, these images can be collected to group similar images. In the case of video generation, a method called GAN, for example, may be used. A new image can be generated by learning from the data set. Thus in the case where data is not labeled, unsupervised learning can be used.

### [17.1] Supervised Learning

In the present embodiment, a convolutional neural network (CNN), which is a type of deep learning, may be used.

CNN has a structure where a convolutional layer and a pooling layer alternately stacked to capture a local feature of the input data. By stacking such layers many times, a more advanced feature extraction becomes possible.

In the supervised learning, labeled data (teacher data), which provides correct output to data to be inputted to the model, is required. When a video of a virtual space is generated, video data generated by the video generating unit 230 is used, for example, as the teacher data, but the teacher data may be acquired via the Internet and stored in the learning storage unit 278.

For example, a processing flow of performing learning using CNN and generating a video based on the learning information is as follows.

First learning information is prepared. For example, in the present embodiment, video data generated by the video generating unit 230 is collected and stored in the learning storage unit 278.

Then a model (learning model) is constructed. That is, a model to generate a video viewed from the virtual camera in the virtual space is constructed using CNN. For the model, the features of the image are extracted using the convolutional layer, and after features are extracted, a video is generated in the fully-connected layer.

Then learning is executed. In other words, the model is trained using the learning information. During the training, the model automatically learns so as to minimize the difference between the input image and the teacher data.

When the training completes, a new video can be generated using the model. In the present embodiment, predetermined information (e.g. information on character when the event is generated) is inputted to the model, and a new video is outputted in the virtual space of the entertainment content.

In other words, a deep learning model, such as CNN, can receive data (e.g. image, text) as input, and perform prediction based on this input. Even in a virtual space, the position and state of the character can be provided to the model of CNN as input data. By using this method, a more realistic video can be generated.

### [17.2] Unsupervised Learning

In the present embodiment, a generative adversarial network (GAN), which is a type of deep learning, may be used. GAN is a method of “unsupervised learning”, in which features are learned without providing labeled data.

The generative adversarial network (GAN) is constituted of two models: a generative model and a discriminative model. The generative model generates a new video based on the data learned from existing videos, and the discriminative model determines whether the generated video is real. By the generative model learning to deceive the discriminative model like this, a more realistic video can be generated.

For example, the processing flow of learning using GAN and generating a video based on the learning information is as follows.

First learning information is prepared. For example, in the present embodiment, video data generated by the video generating unit 230 is collected and stored in the learning storage unit 278.

Then a model is constructed. GAN is constituted of two models, a generative model and a discriminative model. The generative model uses a transposed convolutional layer to generate a video from a noise vector. The discriminative model, on the other hand, uses a convolutional layer to distinguish the generated video from a real video.

Then learning is executed. In other words, the generative model and the discriminative model are trained using the learning information. During the training, the generative model generates a video from an inputted noise vector, and the discriminative model determines whether this video is real. The generative model repeats learning so that the video generated by the discriminative model cannot be distinguished from the real video. In other words, the generative model trains the discriminative model using the real video included in the data set for learning, and a dummy video generated by the generative model. The generative model also uses a video generated by random noise for training.

When the training completes, a new video can be generated using the generative model. A video to be generated can be controlled by providing a random noise vector to the generative model. In the present embodiment, in a case where an event is generated in the virtual space of the entertainment content, a new video may be outputted by inputting information used when an event is generated to the generative model.

### [17.3] Preprocessing

In a case of generating a video viewed from the virtual camera using a model, preprocessing may be performed on the learning information. The purpose of the preprocessing is to extract features of data so as to performing learning more efficiently. For example, in a case of an image, normalizing data, resizing, cropping, color space conversion, and the like, may be performed.

The preprocessing may also be performed for data to be inputted to the learned model (model of which training completed). In some cases where the input data of the video to be generated is the same format as the data used for training the model, preprocessing may be unnecessary. But if the input data is different (e.g. resolution is different, type of image is different) as the data used for training the model, preprocessing may be required.

### [18] APPLICATION EXAMPLES

The present embodiment is applicable not only for a matchup game, but also for a racing game, shooting game, music game, role playing game (RPG), action game, sport game, life simulation game, and the like.

The present embodiment is also applicable to a service for disposing the character (avatar) of the user in a three-dimensional space, so as to enjoy the virtual space.

### [19] OTHERS

The present invention is not limited to the embodiments described above, but may be modified in various ways. For example, any term cited together with another term having a broader meaning than or the same meaning as the term in the description or the drawings can be replaced by the other term in any place in the description or the drawings.

The present invention includes configurations that are substantially the same as the configurations described in the embodiments (e.g. configurations having the same functions, methods and results, or configurations having the same objectives and effects as those of the configurations described in the embodiments). The invention also includes configurations obtained by replacing nonessential elements of the configurations described in the embodiments with other elements. The invention also includes configurations exhibiting the same operations and effects as those of the configurations described in the embodiments, or configurations capable of achieving the same objectives as those of the configurations described in the embodiments. Further, the invention includes configurations obtained by adding known art to the configurations described in the embodiments.

Embodiments of the present invention have been described in detail above, but a person skilled in the art will readily appreciate that various modifications are possible without materially departing from the novel teachings and effects of the invention. Therefore, all such modifications are assumed to be included in the scope of the invention.

REFERENCE SIGNS LIST

| | | | | | |
|---|---|---|---|---|---|
| 10 | Server device, | 20, 20A, 20B, 20C | Terminal device, | | |
| 100 | Processing unit, | 111 | Entertainment control unit, | | |
| 112 | Display control unit, | 119 | Receiving unit, | | |
| 120 | Communication control unit, | 121 | Web processing unit, | | |
| 122 | Management unit, | 123 | Notification unit, | | |
| 160 | Input unit, | 170 | Storage unit, | 171 | Main storage unit, |
| 174 | Entertainment information storage unit, | | | | |
| 176 | Player information storage unit, | | | | |
| 180 | Information storage medium, | 196 | Communication unit, | | |
| 200 | Processing unit, | 211 | Communication control unit, | | |
| 212 | Object space setting unit, | 213 | Movement/action control unit, | | |
| 214 | Operation input receiving unit, | 215 | Entertainment control unit, | | |
| 217 | Behavior control unit, | 218 | Learning unit, | | |
| 219 | Setting unit, | 222 | Providing unit, | | |
| 223 | Virtual camera control unit, | 224 | Selection unit, | | |
| 225 | Storage processing unit, | 230 | Video generating unit, | | |
| 240 | Sound processing unit, | 260 | Input unit, | | |
| 262 | Detection unit, | 270 | Storage unit, | 271 | Main storage unit, |
| 272 | Image buffer, | 274 | Entertainment information storage unit, | | |
| 275 | Video storage unit, | 276 | Player information storage unit, | | |
| 278 | Learning storage unit, | 279 | Learning model storage unit, | | |
| 280 | Information storage medium, | 290 | Display unit, | | |
| 292 | Sound output unit, | 296 | Communication unit | | |

1. An entertainment system which provides a video generated in an entertainment content executed in a virtual space, the entertainment system comprising:
a virtual camera control unit which disposes at least one virtual camera in the virtual space; and
a video generating unit which generates a video viewed from the virtual camera, wherein
learning information related to the video includes evaluation information related to the video, and
the video generating unit generates the video based on the learning information.

2. The entertainment system according to claim 1, wherein
the learning information includes information related to the virtual camera.

3. The entertainment system according to claim 1, wherein
the learning information includes information related to a subject of the virtual camera.

4. The entertainment system according to claim 1, wherein
the learning information includes information related to a game situation.

5. The entertainment system according to claim 1, wherein
the learning information includes information related to image analysis.

6. The entertainment system according to claim 1, wherein
the learning information includes learning information of other players.

7. The entertainment system according to claim 1, wherein
the evaluation information is made for the video and is based on a player's input.

8. The entertainment system according to claim 1, wherein
the evaluation information is made for the video and is provided by a plurality of players.

9. The entertainment system according to claim 1, wherein
the evaluation information is information about difference between the video and a predetermined reference video.

10. The entertainment system according to claim 1, further comprising
a selection unit which selects a video to be provided, out of a plurality of generated videos, based on information input by a player.

11. An information processing device which provides a video generated in an entertainment content executed in a virtual space, the information processing device comprising:
a virtual camera control unit which disposes at least one virtual camera in the virtual space; and
a video generating unit which generates a video viewed from the virtual camera, wherein
learning information related to the video includes evaluation information related to the video, and
the video generating unit generates the video based on the learning information.

12. A video providing method for providing a video generated in an entertainment content executed in a virtual space, the method comprising:
disposing at least one virtual camera in the virtual space; and
generating a video viewed from the virtual camera, wherein
learning information related to the video includes evaluation information related to the video, and
in generating the video, the video is generated based on the learning information.
